(19) United States
(12) Patent Application Publication
(10) Pub. No.: US 2008/0298788 A1
(43) Pub. Date: Dec. 4, 2008

(54) Heated hose apparatus and method

(75) Inventors: Norman S. Martucci, Carkston, MI (US); Rich Hahn, Sterling Heights, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Teleflex Fluid Systems, Inc.

(21) Appl. No.: 11/806,733

(22) Filed: Jun. 4, 2007

(51) Int. Cl. H05B 3/58

(52) U.S. Cl. 392/472; 156/149

(57) ABSTRACT

A heated hose assembly includes: an extruded inner liner; an intermediate layer comprising strands of a nonmetallic material and at least one heating wire each of the nonmetallic material and heating wire interwoven about the exterior of the extruded inner liner; an outer coating dispersed throughout the strands of the intermediate layer, and; a crimp attachment component for attaching the at least one heating wire to a power source.

### FIELD OF THE INVENTION

The present invention relates generally to a heated hose apparatus and method. More particularly, the present invention relates to an apparatus and method for preventing freezing of fluid streams, such as exhaust treatment fluid or the like, by transporting the fluid within a heated hose apparatus.

### BACKGROUND OF THE INVENTION

Hose assemblies used to carry fluid streams are well known in the art. Preferably, these hoses are strong and resistant to heat and chemical degradation. In the fuel-related systems, fluid stream hoses are subject to not only chemical breakdown due to the various fluids that pass through them but are also subject to breakdown from the heat radiating from the engines or exhaust pipes to which the hoses are connected.

It is known in the art that urea solutions, such as “AdBlue”, may be added as a reactant for reducing the amount of nitrogen oxides (NOₓ) in combustion exhaust streams, especially diesel fuel exhaust. The urea reduces toxic NOₓcomponents into normal components of air, such as nitrogen, water and carbon dioxide. In order to reduce the likelihood of the urea freezing, the hose transporting the urea is often times heated.

Conventional methods of heating a hose include attaching heating wires directly to the hose. Such methods of heating hoses are accomplished by utilizing heating wires, which are wound helically or spirally around a plastic layer of the tube of the hose through which the fluid or the like travels. The heating wires are typically spaced close together in order to better heat the tube. However, the positioning and proximity of the heating wires can cause the heating wires to short circuit and therefore, the arrangement of the heating wires is important to prevent the wires from short circuiting.

One method employed to prevent the wires from producing a short circuit is utilizing adhesive insulating tape to position the wires into a desired formation, such as a double helix. However, use of adhesive to attach the wires has drawbacks. First, the process can be time-consuming and messy. Second, during operation, the adhesive or adhesive tape can wear and breakdown, especially when the hose is positioned in close proximity to fuel engines, increasing the likelihood of the hose failing to heat the fluid flowing therethrough.

An additional drawback of the currently available heated hose assemblies is that adhesive cannot be used to attach heating wires to an inner liner that is made essentially of fluorocarbon polymers because it will be infeasible to cause the adhesive to stick. As such, their manufacture is limited to other materials, which typically may not be used to manufacture hoses that may be cut. Thus, these other materials may only be used to make hoses of specific lengths. This length-specific construction can be very limiting and increases production costs.

In addition to the step of adding heating wires, strengthening layers of nonmetallic material are often added to increase durability of the heated hose. However, in manufacturing these heated hoses, the heating wires and the strengthening layer are typically attached to the hose apparatus requiring separate manufacturing steps. The additional manufacturing step adds cost to the end product.

Accordingly, it is desirable to provide an integral heated hose apparatus with increased durability. Moreover, it is desirable to provide an integral heated hose apparatus and method, whereby these heated hoses are cost effective to manufacture at various desired lengths.

### SUMMARY OF THE INVENTION

The foregoing needs are met, to a great extent, by the present invention, wherein in one aspect an integral heated hose apparatus and method is provided that in some embodiments, nonmetallic strengthening material, such as glass fibers may be threaded or braided together with heating wires to form a single unitary layer, which may be attached to the inner liner of the tube. This improved design allows for decreased manufacturing steps, and therefore decreased production costs, for a heated fluid line or the like. The heated hose of the present invention is also less susceptible to wear or breakage in the field. Preferred embodiments of the present hose assembly does not include additional components for attaching the heating wires, such as adhesive tape.

In accordance with one embodiment of the present invention, a heated hose assembly is provided, comprising: an extruded inner liner; an intermediate layer comprising strands of a nonmetallic material and at least one heating wire each of the nonmetallic material and heating wire interwoven about the exterior of the extruded inner liner; an outer coating dispersed throughout the strands of the intermediate layer, and; a crimp attachment component for attaching the at least one heating wire to a power source.

In accordance with another embodiment of the present invention, an example method of making a heated hose assembly is provided, comprising the steps of: extruding an inner liner; interweaving strands of a nonmetallic material and at least one heating wire about the exterior of the inner liner to form an intermediate layer; covering the intermediate layer with a solution having a polymer and a carrier; and removing the carrier, leaving a polymer coating dispersed throughout the strands of the intermediate layer.

In accordance with yet another embodiment of the present invention, an example method of making a heated hose assembly is provided, comprising the steps of: means for extruding an inner liner; means for braiding strands of a nonmetallic material and at least one heating wire about the exterior of the inner liner to form a braided layer; means for passing the inner liner and braided layer through a reservoir containing a solution having a polymer and a carrier; and means for removing the carrier, leaving a polymer coating dispersed throughout the strands of the braided layer.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a heated hose apparatus in accordance with an example embodiment of the present invention.

FIG. 2 is an enlarged cross-sectional view of the heated hose apparatus depicted in FIG. 1.

FIG. 3 is a perspective, schematic view of the heated hose apparatus depicted in FIG. 1.

FIG. 4 is a perspective, schematic view of the heated hose apparatus depicted in FIG. 1 attached to a power source.

### DETAILED DESCRIPTION

The invention will now be described with reference to the drawing figures. Example embodiments of the heated hose of the present invention provide heating wires braided or threaded together with a strengthening material around the inner liner. Essentially, rather than attaching wires to a hose, the present invention provides a heating mechanism that is an integral component of the outer layer of the hose. The integration of the glass fibers with the heating wires allows the glass fibers and heating wires to be added in a single manufacturing step to form a lightweight hose assembly adapted for carrying treated exhaust treatment fluid and other fluids that need to be heated. Furthermore, the wire is braided, not wound, which may provide increased hoop strength for high pressure applications.

The present invention provides an integral heated hose, having a braided layer, which includes heated element wires and glass fibers. The aforementioned braided layer is advantageous because it provides a unitary layer that allows for increased durability while also providing heat to the hose.

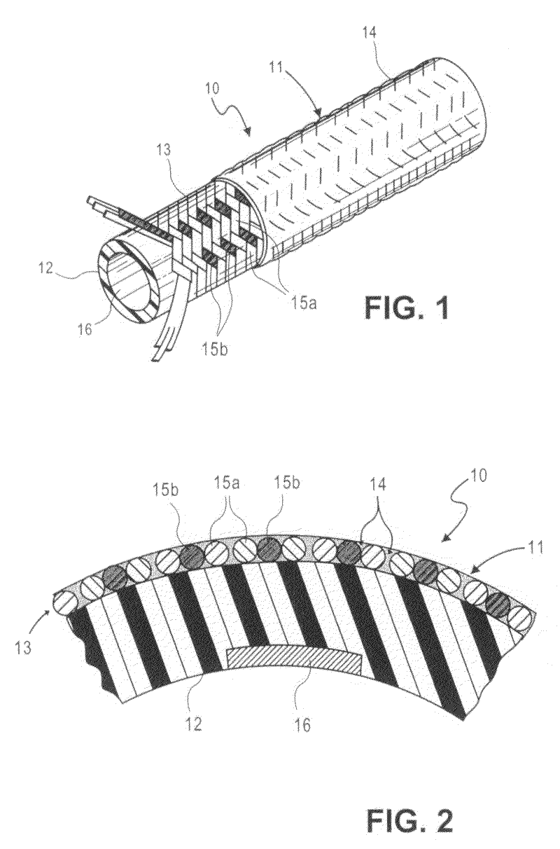

Referring now to FIGS. 1-3, a heated hose assembly 10 in accordance with an embodiment of the present invention is illustrated. The heated hose assembly 10 includes a tubular member, generally designated 11. The tubular member 11 includes an inner liner 12, a braided layer 13 and an outer coating 14. The inner liner 12 may have a conductive inner portion or conductive strip 16 for dissipating electrical charges accumulated. In other embodiments, rather than a conductive strip 16, the inner liner 12 may have a continuous inner layer coating (not shown) comprised of conductive material such as, conductive tetrafluoroethylene (PTFE), and an outer layer coating (not shown) comprised of a natural material such as, natural PTFE. In example embodiments of the present invention, the braided layer 13 includes glass fibers 13a and heating wires 15b. The heating wires may be connected to a power source via a threaded lug or spade 19 that extends from an outer surface of a crimp coupling member 20. A coupling component (not shown) may be used to connect the ends of tubular member 11 to fittings for conducting fluid therethrough.

Referring specifically to FIG. 1, the tubular member 11 includes an inner liner 12 preferably made of an organic polymer. The inner liner 12 is preferably extruded and has a wall thickness of approximately 0.001 to approximately 0.120 inches. The inner liner 12 is preferably made of a fluorocarbon polymer. In preferred embodiments of the present invention, the inner liner can be constructed from various polymers such as, PTFE, fluorinated ethylene propylene (FEP), perfluoroalkoxy resin (PFA), ethelyne-tetrafluoroethylene (ETFE) or engineering polymers such as, nylon and polyester. The fluorocarbon polymers PTEE, FEP, and PFA are sold under the trademark TEFLON by Dupont. The polymer ETFE is sold under the trademark TEFZEL by Dupont.

Because the material does not permeate or chemically react with the fluid, the inner liner 12 is said to be impervious to fluid flow through the wall. Also because the inner liner 12 is preferably made of a polymer material, it is resistant to both heat and chemical degradation. This allows a variety of fluids, particularly vehicle fuel exhaust, to pass through the interior of the liner 12 without corroding the liner 12.

The heated hose assembly 10 further includes a braided or woven layer 13 about the exterior of the inner liner 12, as shown exposed in the left portion of FIG. 1. The braided layer 13 can comprise any nonmetallic material disposed in interweaving fashion or wrapped tightly about the inner liner 12. Preferably the braided layer 13 comprises a series of glass fibers 15a in combination with two or more heating components, such as heating wires 15b. The glass fibers 15a provide strength to the outer layer of the heated hose assembly 10, which allow for the heated hose assembly 10 to be more durable. Furthermore, the glass fibers 15a are heat resistant which is important for use in heated environments and for making the assembly as will be described subsequently.

As depicted in FIG. 1-3, a glass fiber 15a is braided with heating wires 15b and both are positioned about the exterior of the inner liner 12 to form the braided layer 13. The heated hose assembly 10 further includes an outer polymeric coating 14 dispersed throughout the braided layer 13 for preventing kinking or permanent deformation of the inner liner 12. The braided or woven layer 13 includes glass fibers 15a either tightly or loosely wound with the heating wires 15b about the inner liner 12, wherein the glass fibers 15a and heating wires 15b have wide gaps between adjacent fibers. In one preferred embodiment, these braided components, 15a and 15b, are tightly woven such that the gaps or spaces between adjacent components is minimal. The heating wires 15b are wound such that the glass fibers 15a separate the heating wires 15b into a desired formation which prevents the wires from contacting one another and producing a short circuit. The heated hose assembly 10 also includes a conductive strip 16 or alternatively, a conductive inner layer, is formed on the inner liner 12 for dissipating electrical charges accumulated.

Referring now to FIG. 2, an enlarged cross-sectional view of the heated hose assembly 10 illustrated in FIG. 1 is depicted. The heated hose assembly 10 further includes an organic polymeric dispersion or coating 14 in the braided layer 13. Specifically, an organic polymeric material is dispersed about the braided layer 13 and extends from the outer periphery of the braided layer 13 radially inwardly toward the inner liner 12. The organic polymeric material is deposited in the intricies of the braided layer 13.

The coating 14 preferably comprises a polymer. Like the inner liner 12, the coating 14 may be made of polymers such as, PTFE, FEP, PFA, ETFE, polyester or nylon . As previously discussed, the coating 14 covers the strands of the braided layer 13 from the outer periphery radially inwardly. The coating, therefore, does not extend radially outwardly from the outer periphery of the braided layer 13. After the material has been coated, each strand of the braided components is discernible. In effect, what results is a coating 14 having the braided layer 13 therein.

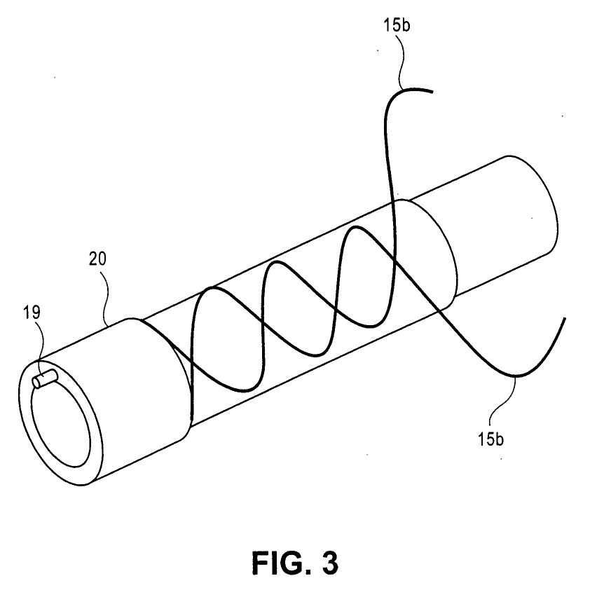

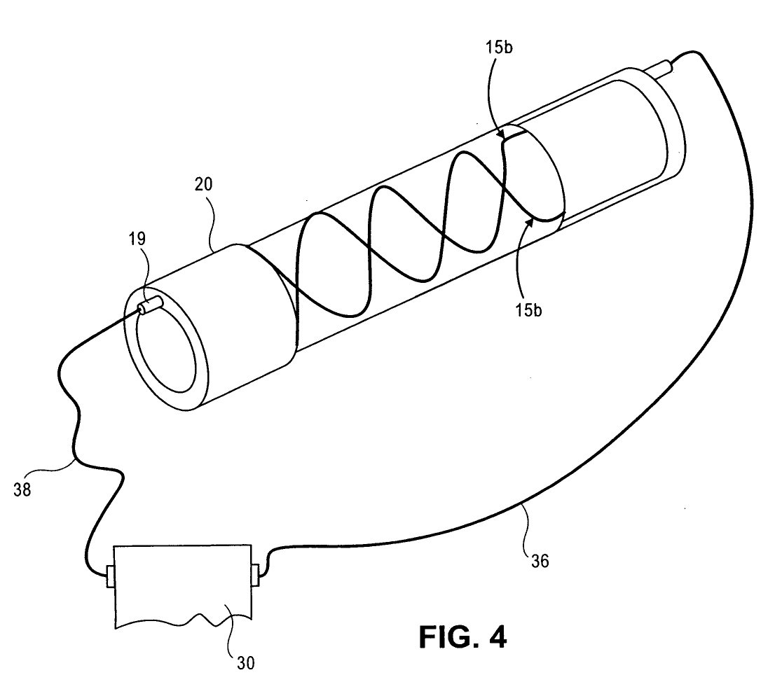

Referring now to FIG. 3, a perspective view of the heated hose assembly 10 is illustrated. FIG. 3 is exemplary only and therefore, only the heating wires 15b of the braided layer 13 are shown. As illustrated, the heated hose assembly 10 includes a crimp attachment component connecting the heating wires to a power source. In one embodiment encompassed by the present invention, the crimp attachment component includes a threaded lug or spade 19 that extends from an outer surface of a crimp coupling member 20. The crimp coupling member 20, in combination with the threaded lug or spade 19 connect to an energy or power source, which powers the heating wires 15b.

Referring now to FIG. 4, a perspective view of the heated hose assembly 10 in accordance with another embodiment is illustrated. FIG. 4 is exemplary of one embodiment encompassed by the present invention depicting the heating wires 15b of the braided layer 13 only. As illustrated, an electrical circuit, a battery 30 or any suitable power source may be connected to the hose assembly 10 and provide power to the heating wires. The electrical circuit or battery 30 may be connected to the heated hose assembly 10 via wires 36, 38, which connect to the threaded lug or spade 19 on each end of the heated hose assembly 10. The wires 36, 38 may additionally include stripped portions (not shown) that have been stripped of polymer to provide an adequate connection point to the power source. The battery 30 provides a current to the wire 36. The current flows through the wire 36 and proceeds to flow through the heating wires 15b, imparting heat on the inner liner 12. The current then proceeds to flow through wire 38 and returns to the battery 30.

As previously discussed, the heated hose assembly 10 may be powered by any power source, for example, a designated battery 30 or it may be tied into an existing electrical circuit of an automobile or the like, with which the heated hose assembly 10 is being utilized. In an embodiment encompassed by the present invention wherein the heated hose assembly 10 is connected to, or tied into an existing electrical circuit, the operation of heated hose assembly 10 may be operated by the ignition of the automobile in which the heated hose assembly 10 is used. Upon ignition of the automobile, a current may be provided to the heated hose assembly 10 via wires 36, 38, as previously discussed, activating the heating wires 15b. Alternatively, the heating hose assembly 10 may be controlled by an automated thermal switch, wherein the switch may be programmed to cycle the heating wires 15b on and off, as required in response to temperature changes.

The preferred method for making a heated hose assembly 10 as shown is as follows. An inner organic polymeric tubular member 12 is provided. Specifically, the inner tubular member 12 of a polymer is extruded. A nonmetallic or wound material (preferably glass fiber) 15a is then braided or wound with several wires 15b about the exterior of the inner liner 12 to form a braided layer 13.

The outer coating 14 is preferably formed after first braiding or interweaving the braided layer 13 about the exterior of the inner liner 12. The organic polymeric material is then dispersed into the braided material 13 from the outer periphery of the braided layer 13 radially inwardly toward the inner liner. Preferably, the organic polymeric material is a polymer in a dispersion. In other words, the coating 14, as applied, comprises the polymer and at least one carrying fluid. The preferable carrying fluid is water. It will be appreciated that any suitable fluid may be used.

The organic polymeric material dispersion 14 may be dispersed throughout the braided layer 13 from the outer periphery radially inwardly toward the inner liner 12. Specifically, the inner liner 12 and braided material are passed through a reservoir containing a dispersion of an organic polymeric material and at least one carrying fluid. Alternatively, the dispersion may be sprayed onto braided material. Preferably, the dispersion is an aqueous dispersion of a polymer. Because the dispersion is preferably aqueous, the carrying fluid used is preferably water. The dispersion is disposed throughout the entire braided layer 13.

The carrying fluid, preferably water, is then removed from the solution, preferably by sending the heated hose assembly 10 to a dryer, a preheat oven which is preferably below the boiling temperature of the carrier (water). By utilizing an oven below the boiling temperature of the carrying fluid, a bubbling effect is avoided in the final product. The temperature can be above the boiling temperature, however, the heated hose assembly 10 may contain many air bubbles in the outer coating 14 if higher temperatures are used.

The carrying fluid (water) is removed to leave a coating 14 of an organic polymeric material dispersed throughout the braided material 13. The heated hose assembly 10 is then sintered at a suitable temperature to cure the organic polymeric coating 14 and connect the braided layer 13 to the inner liner 12 forming a single layer. The glass fibers 15a and heating wires 15b used for the braided layer remain unaffected by the heat required to sinter the heated hose assembly 10. Finally, a coupling member may be secured on one or both ends of the tubular member 11 to secure the heated hose assembly 10 to a fitting for conducting fluid through the inner liner 12.

The polymer dispersion coats or is dispersed throughout the entire braided layer 13. Specifically, the polymer dispersion effectively coats each strand of the braided components from the outer periphery radially inwardly. That is, the braided components are coated such that any gap between adjacent components will be filled with the polymer dispersion by a widening action. Also, the outer periphery of each component is completely coated. The carrying fluid is then removed from the dispersion by drying. This leaves a polymer material dispersed throughout braided layer 13 and therefore connects the braided layer 13 to the inner liner 12 forming a single layer.

Both the inner liner 12 and coating 14 are preferably polymers. It is, however, not necessary that both the inner liner 12 and coating 14 be of the same polymer, although they may be. For example, the inner liner 12 may be made of PFA while the coating 14 is made of PTFE. Any combination of the polymers listed may be utilized for the inner liner 12 and coating 14.

During operation, the heated hose assembly 10 may be used to transport exhaust treatment fluid, such as urea, to an exhaust pipe while the motor is running. The exhaust treatment fluid exits its storage tank and enters the inner liner 12 of the heated hose assembly 10. As the urea flows through the inner liner 12, a drop in temperature may cause the fluid stream to freeze. The fluid may be maintained within a desired temperature range by applying a charge to the heating wires 15b, which supply heat to the inner liner 12. Therefore, the heating wires enable the treatment fluid to be heated as it travels through the heated hose assembly 10.

The braided layer 13 simultaneously heats and strengthens the inner liner 12. By using a braided layer 13, the working pressure of the inner liner 12 is increased, allowing a higher pressure fluid to flow through the inner liner 12. Further, the braided layer 13 adds to the tensile strength of the heated hose assembly 10. When coupling members (not shown) are disposed on the ends of the tubular member 11, the braided layer 13 increases the tensile strength of the heated hose assembly 10 sufficiently to fixedly connect any type of coupling member to the tubular member 11. Finally, the braided layer adds to the hoop strength of the inner liner.

The coating 14 in conjunction with the braided layer 13 allows the inner liner 12 to be bent without kinking. That is, the coating 14 dispersed throughout the braided layer 13 provides strength to the inner liner 12 upon bending. This is commonly referred to as hoop strength. Thus, by using a polymeric coating 14 dispersed throughout the braided layer, a trim profile assembly is produced which results in the hoop strength of the tubular member 11 being increased so that the tubular member 11 can be bent without kinking the inner liner 12. Further, the outer coating 14 adds to the working pressure of the hose. That is, the coating 14 provides strength and allows the inner liner 12 to accommodate a fluid under pressure. Also, the coating 14 hinders abrasion of the tubular member. Said another way, the coating 14 aids in abrasion resistance of the tubular member 11. That is, because the coating is continuous about the outer periphery of the braided layer 13, the braided layer is not subject to abrasion. The coating 14 resists abrasion.

As fluid flows through the inner liner 12, electrical charges may build throughout the length of the inner liner 12. In order to prevent these electrical charges from accumulating, the inner liner 12 has an integral longitudinal conductive component coextensive with the length of the inner liner 12 for conducting an electrical charge through the liner. In some embodiments, the inner liner 12 has a conductive strip 16 of carbon black. This carbon black is electrically conductive and will dissipate any electrical charges built up by the fluid.

Alternatively, the whole inner tubular member 12 can comprise the conductive component. This is done by using carbon black about the entire inner liner 12. The braided layer 13 and coating 14 are preferably electrically non-conductive. This is important to ensure that electrical changes applied to the exterior of the outer coating 14 will not be conducted throughout the length of the tubular member 11 or to the fluid passing through the interior of the inner liner 12. It will be appreciated that other conductive material may be used to form the conductive strip 16 or conductive layer.

It is understood that, although the heated hose assembly 10 of the present invention is described as transporting fuel exhaust from an engine, the heated hose assembly 10 may be used in other applications as well. As mentioned previously, the heated hose assembly is especially useful in transporting any fluid that needs to be heated.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A heated hose assembly, comprising:
an extruded inner liner;
an intermediate layer comprising strands of a nonmetallic material and at least one heating wire each of the nonmetallic material and heating wire interwoven about the exterior of the extruded inner liner;
an outer coating dispersed throughout the strands of the intermediate layer, and;
a crimp attachment component for attaching the at least one heating wire to a power source.

2. The heated hose assembly, as claimed in claim 1, wherein the inner liner is comprised of a first polymer.

3. The heated hose assembly, as claimed in claim 2, wherein the first polymer is at least one of PTEE, FEP, PFA, ETFE, polyester or nylon.

4. The heated hose assembly, as claimed in claim 1, wherein the nonmetallic material strands of the intermediate layer is comprised of glass fiber.

5. The heated hose assembly, as claimed in claim 1, wherein the at least one heating wire is two heating wires.

6. The heated hose assembly, as claimed in claim 1, wherein the outer coating is comprised of a second polymer.

7. The heated hose assembly, as claimed in claim 6, wherein the second polymer is at least one of PTFE, FEP, PFA, ETFE, polyester and nylon.

8. The heated hose assembly, as claimed in claim 1, wherein the crimp attachment component includes a threaded lug that extends from an outer surface of a crimp coupling member.

9. The heated hose assembly, as claimed in claim 1, wherein the extruded inner liner further includes a conductive inner portion for dissipating accumulated electrical charges.

10. The heated hose assembly, as claimed in claim 1, further comprising a coupling component for connecting ends of the heated hose assembly to fittings.

11. The heated hose assembly, as claimed in claim 1, wherein the extruded inner liner has a wall thickness between 0.001 and 0.120 inches.

12. The heated hose assembly, as claimed in claim 1, wherein the extruded inner liner is comprised of a material that is impervious to a fluid flowing through the heated hose assembly.

13. A method of making a heated hose assembly comprising:
extruding an inner liner;
interweaving strands of a nonmetallic material and at least one heating wire about the exterior of the inner liner to form an intermediate layer;
covering the intermediate layer with a solution having a polymer and a carrier; and
removing the carrier, leaving a polymer coating dispersed throughout the strands of the intermediate layer.

14. The method of making a heated hose assembly, as claimed in claim 13, wherein removing the carrier comprises passing the inner liner and intermediate layer having the solution through an oven.

15. The method of making a heated hose assembly, as claimed in claim 14, wherein the oven is preferably below the boiling temperature of the carrier.

16. The method of making a heated hose assembly, as claimed in claim 13, wherein the solution is an aqueous dispersion of the polymer.

17. The method of making a heated hose assembly, as claimed in claim 13, further comprising sintering the inner liner and intermediate layer having the polymer coating at a suitable temperature for curing the heated hose assembly.

18. The method of making a heated hose assembly, as claimed in claim 13, further comprising securing a coupling member onto an end of the heated hose assembly.

19. A method of making a heated hose assembly comprising:
means for extruding an inner liner;
means for braiding strands of a nonmetallic material and at least one heating wire about the exterior of the inner liner to form a braided layer;
means for passing the inner liner and braided layer through a reservoir containing a solution having a polymer and a carrier; and
means for removing the carrier, leaving a polymer coating dispersed throughout the strands of the braided layer.

20. The method of making a heated hose assembly, as claimed in claim 19, wherein means for removing the carrier comprises passing the inner liner and braided layer having the solution through an oven.
